(19) United States
(12) Patent Application Publication
(10) Pub. No.: US 2010/0138783 A1
(43) Pub. Date: Jun. 3, 2010

(54) Image Forming Method, Image Forming Program, And Image Forming Apparatus

(75) Inventors: Chiyoko Sawada, Shinjuku-ku (JP); Tomonori Sato, Machida-shi (JP)

Correspondence Address: SQUIRE, SANDERS & DEMPSEY L.L.P., 1 MARITIME PLAZA, SUITE 300, SAN FRANCISCO, CA, 94111, US

(73) Assignee: Konica Minolta business Technologies Inc., Tokyo (JP)

(21) Appl. No.: 12/404,206

(22) Filed: Mar. 13, 2009

(30) Foreign Application Priority Data
Apr. 23, 2008 (JP) 2008-112393

(51) Int. Cl. G06F 17/30; G06F 3/048

(52) U.S. Cl. 715/808; 707/822; 715/853; 707/E17.01

(57) ABSTRACT

A data delivery apparatus for data delivery to more than one address folder on external equipments, having a storage unit for storing information on one or more data receiving constraints imposed on each address folder, a determination unit for determining availability of each address folder by checking whether or not the current data delivery settings will clear all of the data receiving constraints on each address folder (S101), and a display unit for displaying information on availability of each address folder, which will be accompanied, if any of the data receiving constraints are not cleared, with an error message notifying that these constraints will not be cleared (S102).

### CROSS-REFERENCE TO RELATED APPLICATION

This application is based on Japanese Patent Application No. 2008-112393 filed on Apr. 23, 2008, the contents of which are incorporated herein by reference.

### BACKGROUND

1. Technical Field

The present invention relates to a data delivery apparatus, a data delivery method, and a data delivery program for delivering data such as image data generated by a scanner to external equipments such as file servers.

2. Description of Related Art

In recent years, many offices are equipped with scanners connected to a network and image files generated by the scanners are delivered to folders of external equipment such as in the case of file servers via the network. With a view to improving efficiency in selecting delivery destination folder, a method of referring to a pre-registered address book as well as pre-registered data including past data transmission records has been proposed.

However, reference to those registered data does not guarantee that deliveries to a delivery destination folder registered in the past is available at the present moment, and may present a problem that generating image data with a scanner does not necessarily result in a successful delivery to a desired folder. This problem tends to be caused when a delivery destination file server has been turned off or when access authentication information to a delivery destination folder has been changed.

In this relation, Japanese Unexamined Patent Publication No. 2004-348337 proposes a method of collectively managing on/off status of a personal computer (PC) connected to a network using an administration table, and displaying power-on PCS in distinction from power-off PCs separately on a delivery destination list.

However, even with the abovementioned technique, user has no way to identify the cause of failures in file deliveries except for power-off status of the file delivery destination. Especially, it has been common to change access authentication information periodically in the course of updating a corporate security policy. Also, commonly-used document management application programs can impose various data receiving constrains such as file attribute constraints on delivery destination folders. Under the circumstances, user can come up against a variety of errors in file deliveries, thereby having increased burden in identifying causes of the errors.

### SUMMARY

To achieve at least one of the above mentioned objects or other objects, a data delivery apparatus for data delivery to more than one folder on external equipments, reflecting an aspect of the present invention comprises a storage unit, a determination unit, a display unit, an acquisition unit, and a data delivery unit. Said storage unit stores information on one or more data receiving constraints imposed on each of said folders. Said determination unit determines whether or not each of said folders is available for said data delivery by checking whether or not the current data delivery settings will clear (or overcome) all of said one or more data receiving constraints. Said display unit displays availability information indicating determination result by said determination unit, which is accompanied, if any of said data receiving constraints will not be cleared, by messages notifying that said any data receiving constraints will not be cleared. Said acquisition unit acquires user's designation of destination folders for said data delivery among those which said determination unit has determined that are available for said data delivery. Said data delivery unit executes said data delivery to said destination folders according to said designation acquired by said acquisition unit.

In said data delivering apparatus, said data receiving constraints preferably include at least those due to connection constraint to said external equipments, access constraint to said folders, or meta-information of said folders.

In said data delivery apparatus, said display unit is preferably capable of displaying information on those among said folders which said determination unit has determined that are not available for said data delivery, in distinction from information on those among said folders which said determination unit has determined that are available for said data delivery.

In said data delivery apparatus, at least part of said folders are preferably managed by a document management application installed on said external equipments, and said data receiving constraints on those among said folders which are managed by said document management application are prescribed by said document management application.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall configuration of the image forming system according to the first embodiment of the present invention.

FIG. 2 is a block diagram showing the overall configuration of the Multi-Functional Peripheral (MFP) according to the first embodiment of the present invention.

FIG. 3 is a block diagram showing the overall configuration of the PC according to the first embodiment of the present invention.

FIG. 4 is a block diagram showing the conceptual configuration of a storage unit of the PC according to the first embodiment of the present invention.

FIG. 5 is a block diagram showing the overall configuration of a file server according to a first embodiment of the present invention.

FIG. 6A is a diagram showing the configuration of the address folder database.

FIG. 6B is a diagram showing the configuration of the address folder database.

FIG. 7 is a schematic diagram showing the UI screen for designating delivery destination folders according to the first embodiment of the present invention.

FIG. 8 is a flowchart showing the sequence of the data delivery process according to the first embodiment of the present embodiment.

FIG. 9 is a flowchart showing the sequence of the database updating process according to the first embodiment of the present embodiment.

FIG. 10 is a flowchart showing the sequence of the database updating process according to the first embodiment of the present embodiment.

FIG. 11 is a flowchart showing the sequence of the database updating process according to the first embodiment of the present embodiment.

FIG. 12 is a flowchart showing the sequence of the database updating process according to the first embodiment of the present embodiment.

FIG. 13 is a flowchart showing the sequence of the element updating process according to the first embodiment of the present embodiment.

FIG. 14 is a flowchart showing the sequence of the first data expansion process according to the first embodiment of the present embodiment.

FIG. 15 is a flowchart showing the sequence of the second data expansion process according to the first embodiment of the present embodiment.

FIG. 16 is a block diagram showing the overall configuration of an image forming system according to the second embodiment of the present invention.

FIG. 17 is a block diagram showing the conceptual configuration of a storage unit of the PC according to the second embodiment of the present invention.

FIG. 18 is a schematic diagram showing the UI screen for designating delivery destination folders according to the second embodiment of the present invention.

### DETAILED DESCRIPTION

The embodiment of this invention will be described below with reference to the accompanying drawings.

### First Embodiment

System Configuration

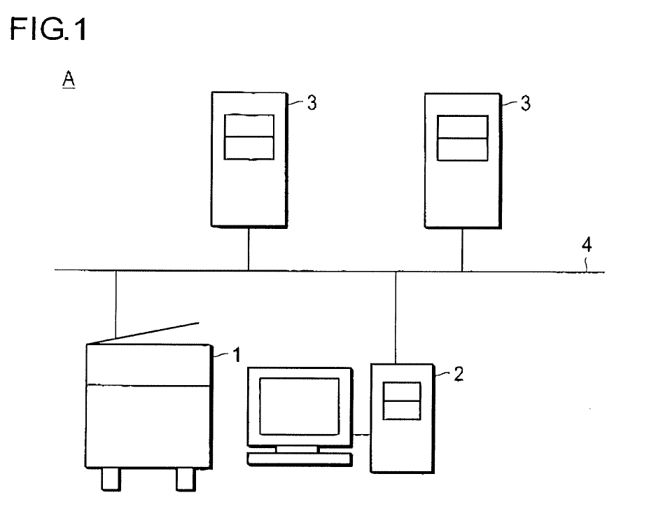

FIG. 1 is a block diagram showing the overall configuration of an image forming system A according to the first embodiment of the present invention. As shown in FIG. 1, the image forming system A contains an MFP 1 equipped with a scanning function for scanning a document image to generate image data, a PC 2 (data delivery apparatus) equipped with a data delivery function for delivering the image data generated by the MFP 1 and delivering it to the host apparatus, and one or more file servers 3 (host apparatus) which can be delivery destinations of the image data, and all of them are connected via a communication network 4, such as the Internet, LAN, WAN, etc. The types and the number of equipment to be connected to the communication network 4 are not limited to the example shown in FIG. 1.

The configuration of each device will be described below while each device can also include any other constituents than those described below and can only include part of the constituents described below. Descriptions of any functions common to more than one device will be made only once, and will not be repeated for avoiding redundancy.

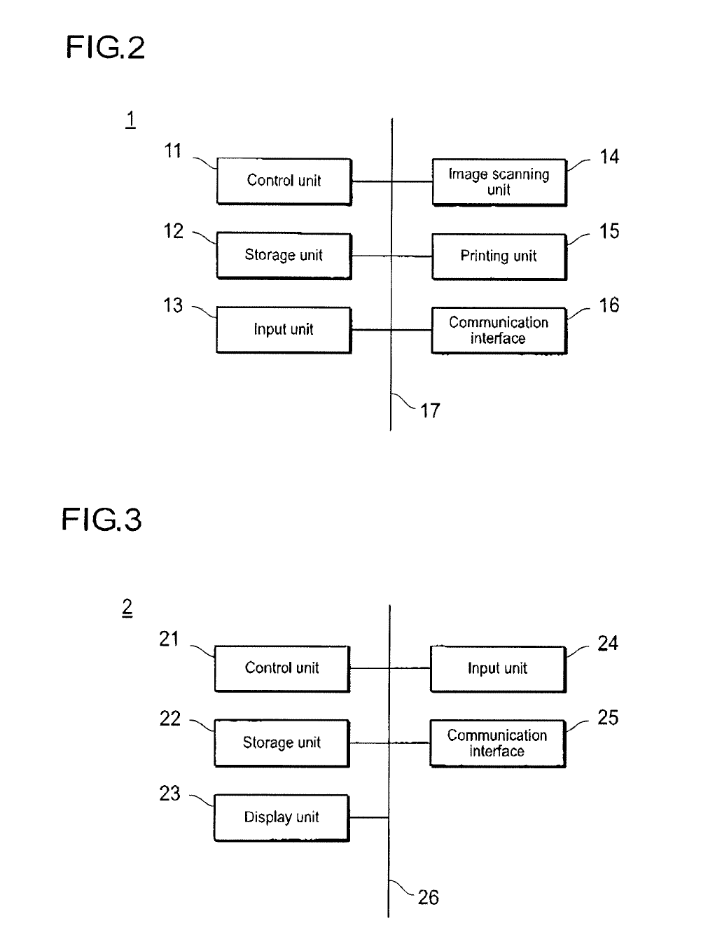

FIG. 2 is a block diagram showing the configuration of an MFP 1 according to the present embodiment. As shown in FIG. 2, the MFP 1 contains a control unit 11, a storage unit 12, an input unit 13, an image scanning unit 14, a printing unit 15, and a communication interface 16, all of which are interconnected via a bus 17 for exchanging signals.

The control unit 11 is a CPU, and controls various parts indicated above and executes various arithmetic processes according to a program.

The storage unit 12 includes a ROM for storing various programs and parameters, a RAM for temporarily storing programs and data, a hard disk used for temporarily storing the image data generated by the scanning of the image scanning device 12, and others.

The input unit 13 consists of a touch panel for displaying various kinds of information and acquiring various inputs from user, a ten-key unit for acquiring various inputs such as the number of copies to be made, a start key for acquiring an instruction to start an operation, a stop key for acquiring an instruction stop the operation, various fixed keys such as a reset key for acquiring an instruction to initialize various settings, display lamps, etc.

The image scanning unit 14 performs the scanning operation which consists of irradiating by a light source such as a fluorescent lamp a document placed on a specified scanning position on a platen, or a document transferred to a specified scanning position by an ADF (Auto Document Feeder), and converting the scanned image to electrical signals by means of a CCD image sensor or a CMOS image sensor to generate image data (bitmap data) from the electrical signals.

Printing unit 15 prints image data on printing paper by the electronic photography method comprising the steps of electrostatic charging, exposure, development, transferring and fixing, and finally discharges the printed paper. However, the printing method employed by the printing unit 15 in this invention is not limited to this, and other printing methods such as the impact method, thermal transfer method, inkjet method, etc. can be used in place of the electronic photography method.

The communication interface 16 is an interface for communications between the MFP 1 and the external equipment, and typically be a network interface using protocols like Ethernet (trademark), Token Ring, and FDDI, a serial interface like USB and IEEE 1394, a parallel interface like SCSI and IEEE 1284, and a wireless communication interface like Bluetooth (a registered trademark) IEEE 802.11, HomeRF and IrDA, as well as a telephone circuit interface for connection to telephone circuits.

The abovementioned configurations enable the MFP 1 to function as a scanner for scanning a document and transmitting the scanned image data to an external equipment, a printer for printing image data received from an external equipment, a copying machine for scanning a document to print it, and as a facsimile machine for receiving and transmitting image data through a telephone circuit.

FIG. 3 is a block diagram showing the configuration of the PC 2 according to the present embodiment. As shown in FIG. 3, the PC 2 contains a control unit 21, a storage unit 22, a display unit 23, an input unit 24, and a communication interface 25, all of which are interconnected via a bus 26 for exchanging signals.

The control unit 21, is a CPU, and controls various parts indicated above and executes various arithmetic processes according to a program. The storage unit 22 consists of a ROM for storing various programs and parameters, a RAM for storing programs and data temporarily as a working area, a hard disk for storing OS (operating system and basic software), programs, and parameters for controlling various operations of the PC 2, and others.

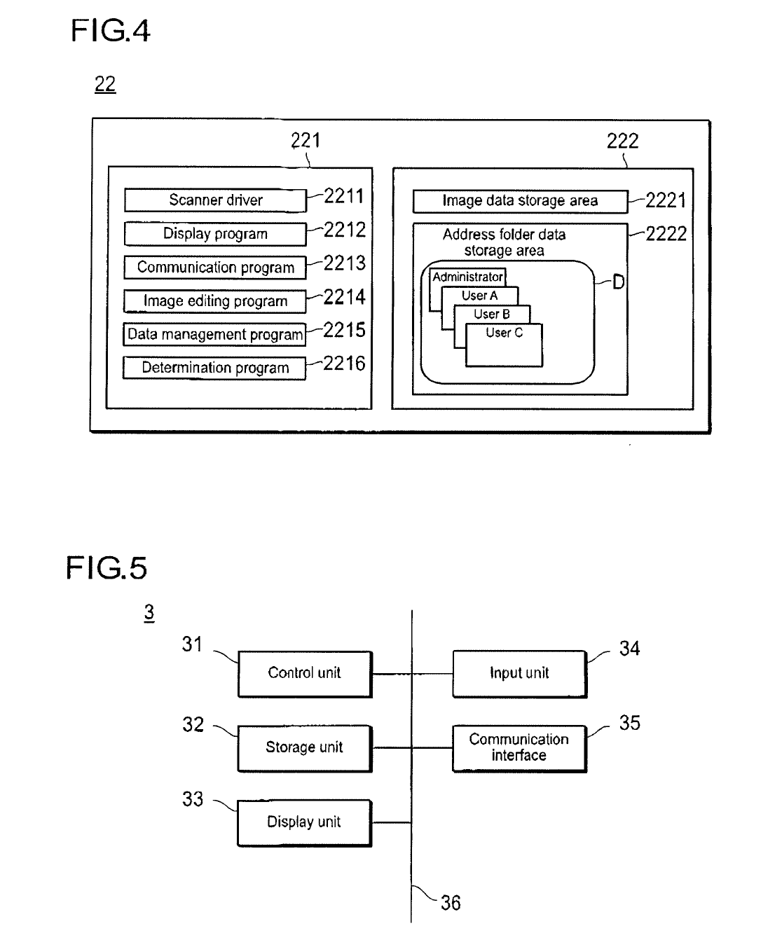

FIG. 4 is a block diagram showing the configuration of the storage unit 22. As shown in FIG. 4, the storage unit 22 includes a program storage area 221 for storing various programs, and a data storage area 222 for storing the image data received from the MFP 1 for delivery purposes and parameters and the likes to be consulted with during the execution of various programs.

The program storage area 221 stores a scanner driver 2211 for configuring the scanning function of the MFP 1 as well as for remote controlling the MFP 1 for its scanning operation, a display program 2212 for displaying on the display unit 23 various UI (User Interface) screens concerning settings on the scanning operation in conjunction with the scanner driver 2211, a communication program 2213 for exchanging various data with the MFP 1, the file server 3, and others, an image editing program 2214 for editing the image data received from the MFP 1, a data management program 2215 for managing the data stored in the address folder database D to be described later, and a determination program 2216 for determining whether or not data delivery is executable.

The data storage area 222 contains an image data storage area 2221 for storing image data which has been generated by the scanning operation of the MFP 1 and is to be transmitted to the PC 2, an address folder data storage area 2222 for storing the address folder database D for collectively managing various kinds of data per user concerning the address folders which have been preliminary registered in an address book as possible delivery destinations of the image data (hereinafter called “address folders”), etc. Details of the address folder database D will be described later.

The display unit 23 is a CRT display, a liquid crystal display and the likes, and displays various kinds of information to user. In particular, the display unit 23 displays the UI screen u1 for user to select delivery destinations of the image data to be generated by the scanning operation. Details of the UI screen u1 will be described later.

The input unit 24 consists of keyboard, mouse and the likes, for acquiring various instructions from user. The communication interface 24 is an interface for communicating with other devices on the network 3 using protocols as Ethernet (registered trademark), Token Ring, FDDI, etc.

FIG. 5 is a block diagram showing the configuration of the file server 3 according to the present embodiment. The file server 3 is a computer with functions to store and transfer files, and is equipped with a control unit 31, a storage unit 32, a display unit 33, an input unit 34, and a communication interface 35, all of which are connected one another via a bus 36 for exchanging signals, as shown in FIG. 5.

The control unit 31 is a CPU, and controls various components described above, and executes various arithmetic processes according to a program. The storage unit 32 consists of a ROM for storing various programs and parameters, a RAM for storing programs and data temporarily as a working area, a hard disk provided with delivery destination folders for storing OS (operating system and basic software), programs, parameters and the likes for controlling various operations of the server 3 as well as scanned image data delivered from the PC 2, and others.

The display unit 33 is a CRT display, a liquid crystal display and the likes, and displays various kinds of information for the user. The input unit 34 consists of keyboard, mouse and the likes, for acquiring various instructions from user. The communication interface 34 is an interface for communicating with other devices on the network via the network 3 using protocols such as Ethernet (registered trademark), Token Ring, FDDI, etc.

The file server 3 of the present embodiment can have a so-called document management application installed on itself, and each of the address folders is subject to various data receiving constraints prescribed by the document management application. The data receiving constraints typically include those attributed to access authentication to the address folders, acceptable data format to the address folders, acceptable data size to the address folders, and so forth. Details of the data receiving constraints will be described later.

Address Folder Database

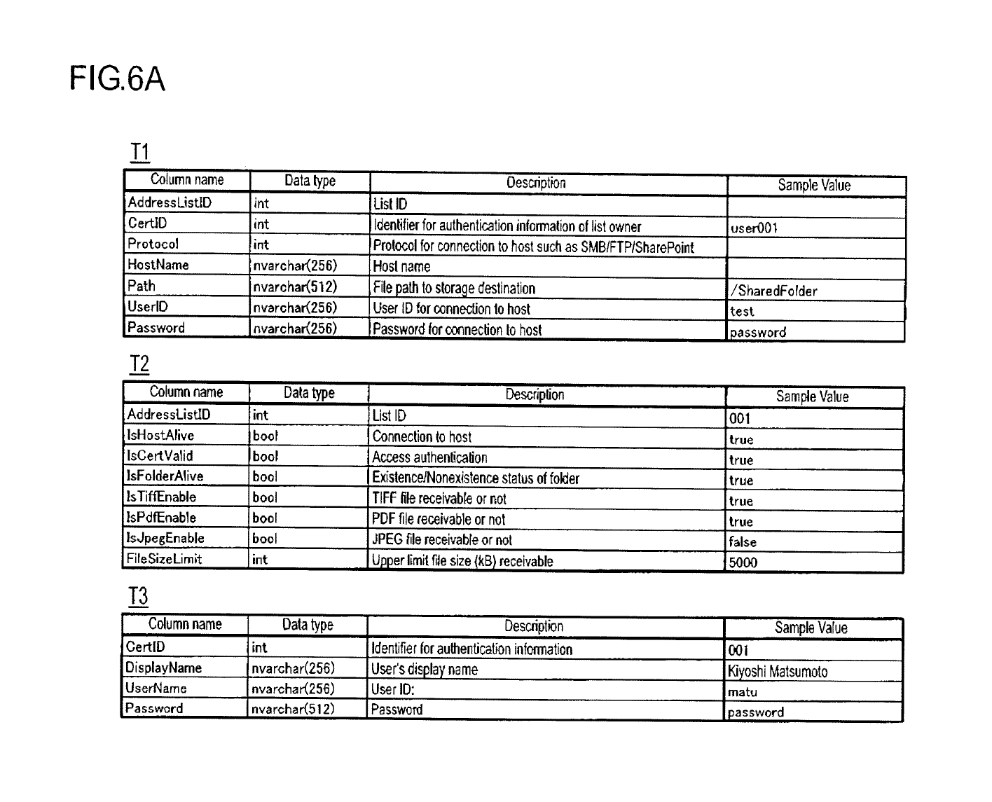

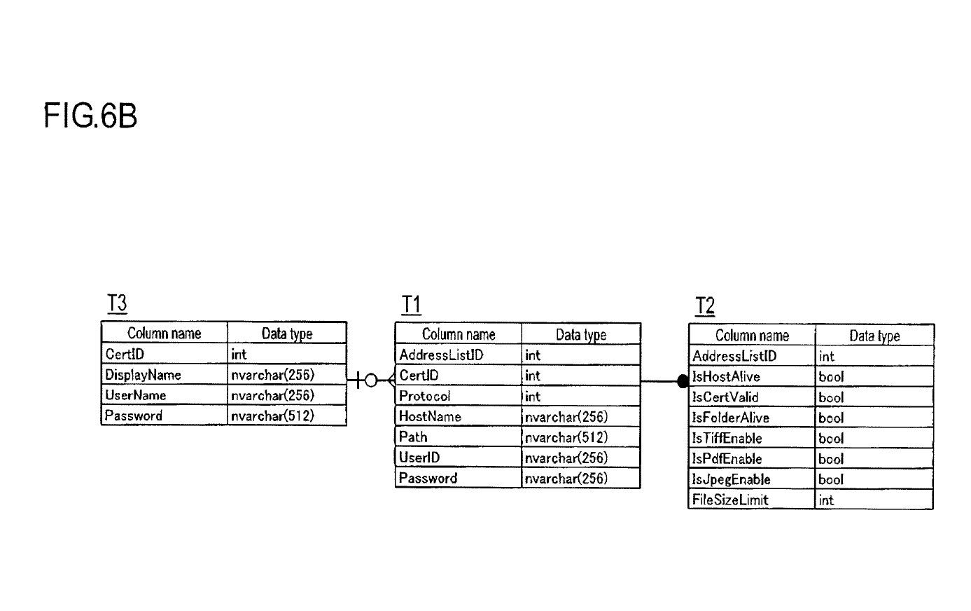

FIG. 6A and FIG. 6B are diagrams showing the configurations of address folder database D. As mentioned before, the address folder database D is a database for collectively storing and managing various data concerning the address folders per-user basis. FIG. 6A is a schematic diagram showing the conceptual configuration of the address folder database D, and FIG. 6B is an ER (Entity Relationship) diagram corresponding to FIG. 6A.

As shown in FIG. 6A, the address folder database D consists of various tables including identification information tables T1 for storing identification information of each address folder, constraints information tables T2 for storing information concerning data receiving constraints imposed on each address folder, and authentication information tables T3 for storing authentication information for access to each address folder. Column names of the tables as well as data types, data descriptions and sample values corresponding to the columns are also shown in FIG. 6A.

In particular, the data receiving constraints stored in the constraints information table T2 include data receiving constraints attributed to connection constraint to the host apparatus (file server 3) equipped with address folders, access constraint to address folders, and meta-information of address folders. The meta-information of address folders includes information on acceptable data formats and acceptable maximum file size to address folders, etc.

Moreover, as shown in FIG. 6B, each of the authentication information tables T3, which is created on per-user basis, corresponds to as many identification information tables T1 as the number of address folders registered for each user, and each of the identification information tables T1 corresponds to one of the constraints information tables T2.

UI Screen

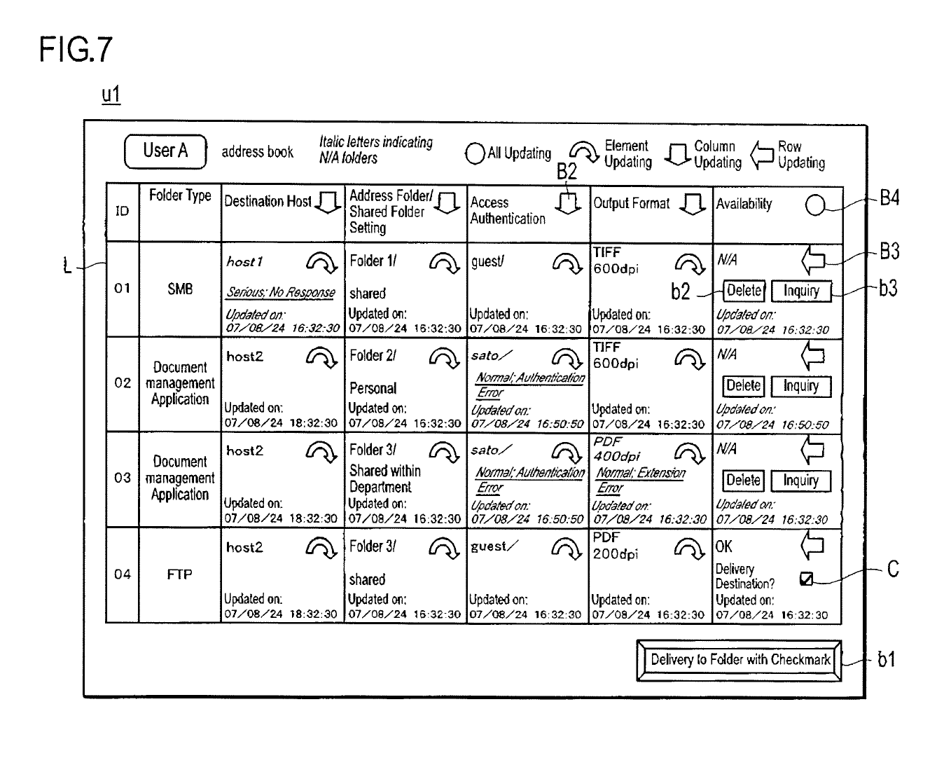

FIG. 7 is a schematic diagram showing an example of UI screen u1 for designating delivery destinations. As described before, the UI screen u1 appears on the display unit 23 of the PC 2 when the MFP 1 starts the scanning operation.

As shown in FIG. 7, the UI screen u1 can display information concerning availability of each address folders associated with long-in user (i.e. “OK” or “N/A”) as well as the reasons for unavailable address folders, if any (e.g. “No Response”, “Authentication Error”, “Extension Error”, etc.).

More specifically, the UI screen u1 displays the address folder list L containing detailed information concerning individual address folders for user's convenience. Each row of the list L corresponds to each address folder. Consequently, log-in user (use A) has four address folders associated with itself.

Each column of the address folder list L displays basic information on the address folders (“ID”, “Folder Type”, “Shared Folder Setting”), information on data receiving constraints on the address folders (“Destination Host”, “Access Authentication”, “Output Format”), and information on availability of the address folders (“Availability”). The details of these columns are as follows:

The “ID” column shows the ID number of each address folder. The ID number of each address folder corresponds to the order of its registration to the address folder database.

The “Folder Type” column shows type of each address folder. More specifically, “Folder Type” shows the type of communication protocol to be used for data delivery to each address folder, and can also indicate whether each address folder is managed by a document management application.

The “Destination Host” column shows the name of the host apparatus equipped with the address folders. The column “Destination Host” also shows an error message like “No Response” in the case where the current data delivery settings on the PC 2 does not clear the data receiving constraints on the destination host (file server 3) i.e. in the case where the “IsHostAlive” value in the table 2 representing the on/off status of the destination host turns out to be “False”.

The “Shared Folder Setting” column shows names of address folders and information on shared folder settings on the address folders. In this respect, the “Shared Folder Setting” column states “Shared Folder” if an address folder can be freely accessed by any user while it states “Personal Folder” when the folder can only be accessed by a log-in user, and “Shared Folder within Department” when the folder can only be accessed by members of a department including the log-in user.

The “Access Authentication” column shows the status of access constraints to address folders. More specifically, The “Access Authentication” column states part of the access authentication information to an address folder (“UserName”, “Password”, etc.) stored in the table T3 when access to the address folder is controlled. In the example of FIG. 7, the column states an user ID (“sato”). On the other hand, the column can also state a text indicating that access to the address folder is not controlled. In the example of FIG. 7, the access authentication column shows “guest” indicating that any user can freely access the folder. If the current data delivery settings on the PC 2 can not clear the data receiving constraints due to access constraint to the address folder i.e. when the “IsCertValid” value representing the access authentication result based on the abovementioned authentication information turns out “False”, the column displays an error message like “Authentication Error” etc.

The “Output Format” column shows the data delivery settings on the PC 2, especially file format of the data to be delivered. If the settings on the output format fail to clear the data receiving constraints concerning file format which are represented by “IsTiffEnable”, “IsPdfEnable” and “IsJpegEnable” values, this column displays an error message like “Extension Error”. In the example shown in FIG. 6A, the table T2 states that the address folder cannot accept JPEG files. As a result, an error message “Extension Error” will appear in the column when user tries to deliver a JPEG file to the address folder.

The “Availability” column shows “OK” or “N/A”, indicating whether or not the address folder is currently available for data delivery. More specifically, the “Availability” column shows OK” when the current settings on the PC 2 clear all the data receiving constraints stored in the address folder database D, and shows “N/A” in turn when the current settings on the PC 2 don't clear them. This will be described later in more details.

The UI screen u1 of the present embodiment can also make information on the address folders with their “Availability” being “N/A”, distinct from information on the other address folders. In the example of FIG. 7, the contents of the column of “Availability” as well as the contents of other columns containing error messages can be shown in italic. Apart from this example, information on the address folders with their Availability being “NG” can be shown in a different color from information on the other address folders.

In addition to the function to display availability of each address folder, the UI screen u1 also has a function to acquire user's instruction to update the address folder list L, and user's designation of delivery destination folders. For these purposes, the UI screen u1 of FIG. 7 is equipped with four kinds of updating buttons B1-B4 for updating the address folder list L, checkbox C for designating an address folder as a delivery destination folder, and the execution button b1 for executing the data delivery to the delivery destination folder. Details of the four updating buttons B1-B4 are described below.

“Element Updating” button B1 is mounted on each of the elements belonging to the columns of “Destination Host”, “Shared Folder Setting”, “Access Authentication”, and “Output format”, in order to allow user to update the address folder list L on a per-element basis.

The “Column updating” button B2 is mounted on each of the columns in the address folder list L except for “ID”, “Folder Type”, and “Availability”, and this button allows user to updated all the elements belonging to an user-specified column.

The “Row updating” button B3 is mounted on each of the rows in the list L, and this button allows user to update all the elements belonging to an user-specified row.

The address folder list L is provided with the only one “All Updating” button B4, and this button allows user to update all the elements in the list L.

In addition to the above, a checkbox C for designating an address folder as a delivery destination is given to a row corresponding to an address folder with its availability being “OK”, and a deletion button b2 for deleting an address folder from the address folder list L, an inquiry button b3 for making an inquiry to a system manager by email are given to a row corresponding to an address folder with its availability being “N/A”.

Image Data Delivery Process

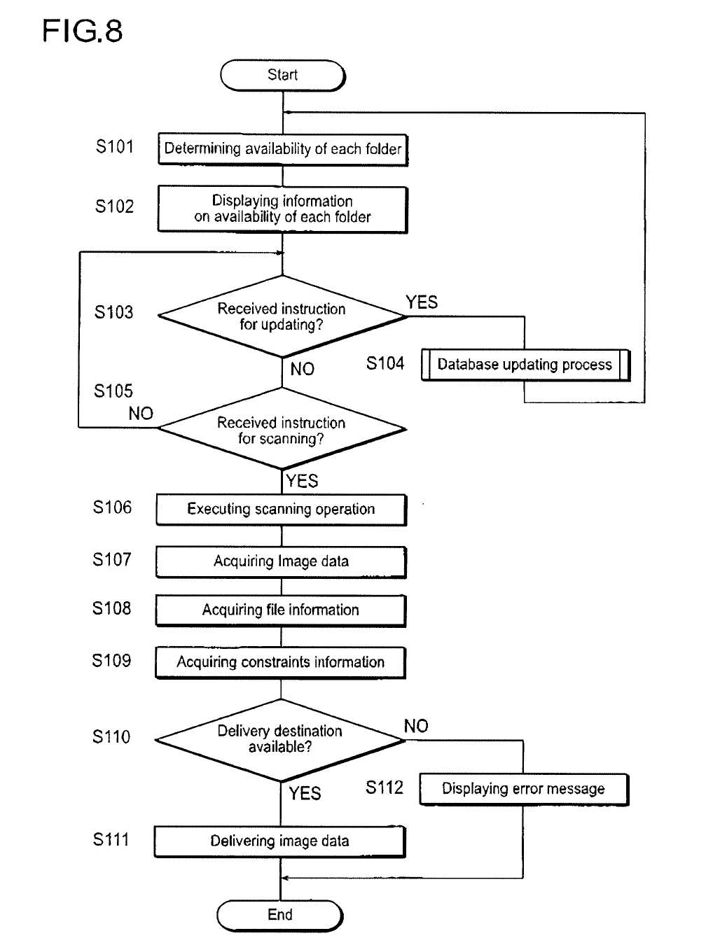

The following is the outline of the operation of the image forming system A in the present embodiment. FIG. 8 is a flowchart showing the sequence of image data delivery process executed by the PC 2. The algorithm indicated by the flowchart of FIG. 8 is stored as a control program on memory 22 of the PC 2, and is read out and executed by control unit 21 when the operation starts.

First of all, upon recognizing a log-in user, the PC 2 refers to the address folder database D in order to determine availability of each address folder (S101). More specifically, the PC 2 checks whether or not its current settings on data delivery stored in the data storage area 222 clear all the data receiving constraints stored in the address folder database D. The PC 2 determines that an address folder is available for data delivery when its current settings clear all the data receiving constraints.

The PC 2 then displays on the display unit 23 information on the check results in S101 (S102), and these results will be accompanied by error messages when any of the data receiving constraints are not cleared. More specifically, the PC 2 displays a UI screen like the one shown in FIG. 7 on the display unit 23. The content of the error message to be displayed in this step depends on type of the data receiving constraint which has not been cleared. For example, an error message “No Response” will appear when the subject constraint relates to connection status to a host apparatus, and an error message “Authentication Error” will appear when the subject constraint is access constraint to an address folder.

The PC 2 then checks whether or not it has received user's instruction to update the address folder list L i.e. whether or not user has pushed or depressed any of the updating buttons B1-B4 on the UI screen u1 (S103).

If any of the updating buttons has been pushed (S103: Yes), the PC 2 returns to S101 after executing the database updating process (S104) for updating selected pieces of information in the address folder database D, and refreshes the U1 screen u1 based on the address folder database D after the updating process (S102). The detail of the database updating process (S104) will be described later.

On the other hand, if none of the updating buttons has been pushed (S103: No), the PC 2 further checks whether or not it has received user's instruction to start the scanning operation (S105). The PC 2 can receive the instruction to start the scanning operation from user operating a UI screen for scan settings (not shown) offered by the scanner driver 2211.

If the PC has received the instruction (S105: Yes), the PC 2 then causes the image scanning unit 14 to start the scanning operation by remote-controlling the MFP 1 via the scanner driver 2211 (S106). Then the PC 2 acquires image data generated through the scanning operation (S107), and stores it into the image data storage area 2221. On the other hand, if the PC 2 has not received the instruction (S105: No), the PC 2 returns to S103.

The PC 2 then acquires file information corresponding to the image data acquired in S107 (S108). The file information herein includes file size of the image data. The PC 2 further acquires from the address folder database D information on the data receiving constraints (hereinafter called as “constraints information”) imposed on the particular folder designated as delivery destination by user operating the UI screen u1 (S109). User can designate a folder as a delivery destination by check-marking the checkbox C in the UI screen u1.

The constraints information acquired in S109 should be relevant to the file information acquired in S108. For example, if the file information acquired in S108 is file size, the constraints information to be acquired in S109 should be the upper limit file size that can be acceptable to the delivery destination folder. In the example of FIG. 6A, the constraints information acquired in S109 is the value of “FileSizeLimit” in the table T2. Meanwhile, the PC 2 can also connect to the destination host in order to acquire the constraints information, rather than contacting the address folder database D.

The PC 2 finally checks availability of the delivery destination folder. More specifically, the PC 2 checks whether or not the file information acquired in S108 clears the data receiving constraints acquired in S109 (S110). If the PC 2 determines that the delivery destination folder is available (S110: Yes), in other words, if the file information fully clears the data receiving constraints, the PC 2 delivers the image data to the user-specified delivery destination folder (S111), and terminates the process (End). On the other hand, if the PC 2 determines that the delivery destination folder is not available at this moment, in other words, if the file information does not clear the data receiving constraints, the PC 2 displays an error message on the display unit 23 (S112), and terminated the process without delivering the image data (End). The content of the error message displayed in this step depends on the data receiving constraint which has not been cleared, and can typically be “Not Enough Space Left”, etc.

As can be seen in the above, the image forming system A of the present embodiment is capable of displaying not only information on availability of each address folder, but also an error message indicating the reason why any of the address folders are not available at this moment (S102). Thus, User can easily identify the reason for unavailability of address folders, if any, in order to take necessary measures to address the reason for the unavailability. For example, an error message “No response” appears with respect to user's own PC, user is then supposed to turn on its PC in order to make the address folders on the PC available for data reception. Similarly, user is supposed to contact its system administrator in order to make address folders on a shared server available when an error message “No Response” appears with respect to the shared server. User is also supposed to change data delivery settings of the PC 2 when an error message of “Extension Error” appears.

Database Updating Process (S104)

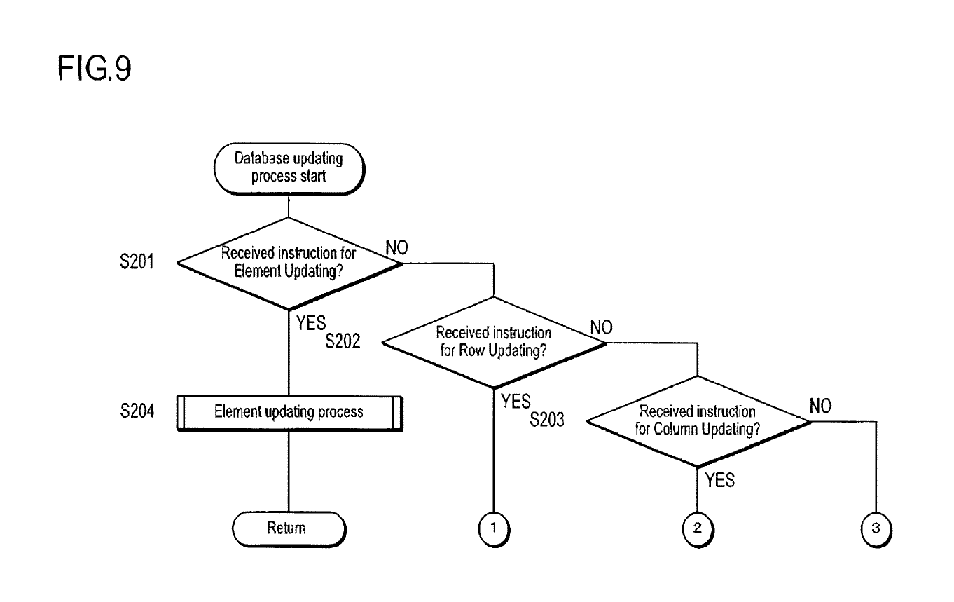

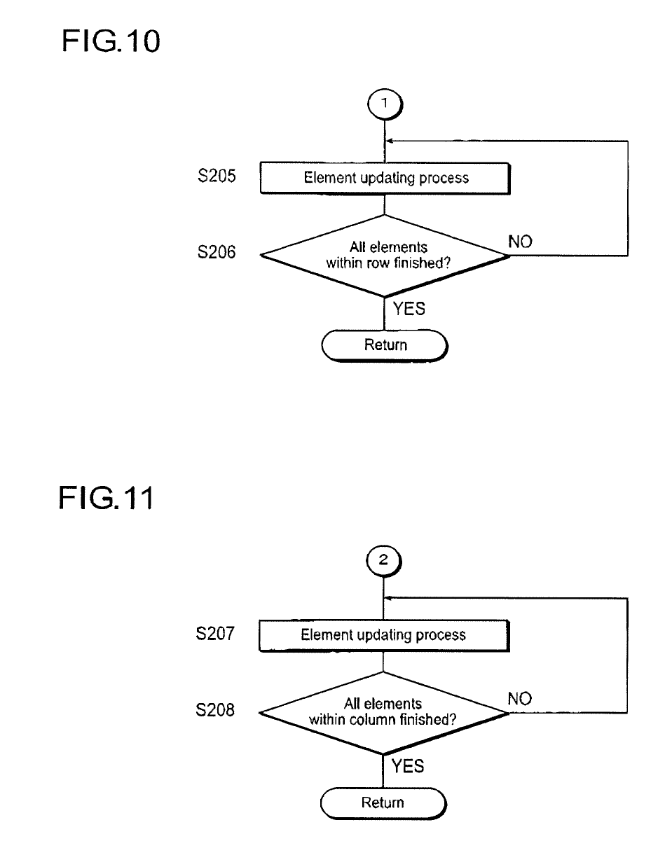

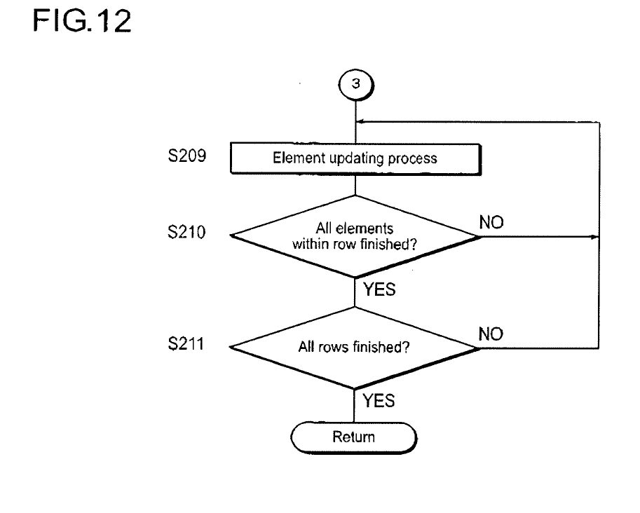

The following is a description of the database updating process in S104. As can be seen from the above, the present embodiment can cause the system to update the address folder database D in a certain unit like an element, a column, a row, or all elements of the address folder list L, by means of the UI screen u1 equipped with a plurality of updating buttons B1-B4 as shown in FIG. 7. For example, user can update information related to the column “Destination Host” in the UI screen u1 of FIG. 7 alone (i.e. the value of “IsHostAlive”) by pushing the updating button B2 corresponding to that column. Similarly, user can update information related to the column “Access Authentication” in the UI screen u1 alone (i.e. the values of “IsHostAlive”, “IsFolderAlive” and “IsCertValid”) by pushing the updating button B2 corresponding to that column. Details of the database updating process will be described later with reference to FIG. 9-FIG. 12. In the present embodiment, user-selectable units for updating the database D are “All”, “Element”, “Column” and “Row” of the address folder list L.

First of all, the PC 2 checks which unit (“All Updating”, “Element Updating”, “Column Updating” or “Row Updating”) has been chosen by user (S201-S203), and the rest of the process diverges according to the check result.

In the case where “Element Updating” has been chose by user (S201: Yes) i.e. any of the buttons B1 in the UI screen u1 has been pushed, the PC 2 executes the element updating process (S204), and then returns to the flowchart of FIG. 8 (Return). The details of the element updating process in S204 will be given later.

In the case where “Row Updating” has been choose by user (S201: No, S202: Yes) i.e. any of the buttons B3 in the UI screen u1 has been pushed, the PC 2 subjects all the elements belonging to the user-specified row of the list L to the element updating process (S205). The process of S205 is identical with S204, and therefore its details are not discussed here. The PC 2 then checks whether or not all the elements within the specified row have been finished with the process of S205 (S206). The PC 2 repeats the process of 205 until all the elements within the row have been finished with the process of S205 (S206: No), and then returns to the flowchart of FIG. 8 when all the elements has been finished with the process of S205 (S206: Yes).

In the case where “Column Updating” has been chose by user (S201: No, S202: No, S203: Yes) i.e. any one of the updating buttons B2 in the UI screen u1 has been pushed, the PC 2 subjects all the elements belonging to the user-specified column in the list L to the element updating process (S207). The process of S207 is identical with S204, and therefore its details are not discussed here. The PC 2 then checks whether or not all the elements within the user-specified column have been finished with the process of S207 (S208). The PC 2 repeats the process of S207 until all the elements within the column have been finished with it (S208: No), and then returns to the flowchart of FIG. 8 when all the elements within the column have been finished (S208: Yes).

In the case where “All Updating” has been chose by user (S201: No, S202: No, S203: No) i.e. the updating button B4 in the UI screen u1 has been pushed, the PC 2 subjects all the elements belonging to any one of the rows in the list L to the element updating process. The process of S209-S210 is identical with S205-S206, and therefore its details are not discussed here. When all the elements within the row have been finished with the process of S209-S210 (S210: Yes), the PC 2 checks whether or not all the rows within the list L have been finished with the process of S209-S210 (S211). The PC 2 then repeats the process of S209-S210 until all the rows have been finished with the process of S209-S210 (S211: No), and returns to the flowchart of FIG. 8 when all the rows have been finished with it (S211: Yes).

As can be seen from the above, the image forming system A of the present embodiment can update the content of the address folder database D in various units such as an “Element”, a “Row”, a “Column”, “All” of the list L, by means of the updating buttons B1-B4 in the UI screen u1 (S201-S203). This will contribute to minimizing the amount of data to be updated, and thereby to reducing load on networks and time for updating the database D.

Element Updating Process (S204)

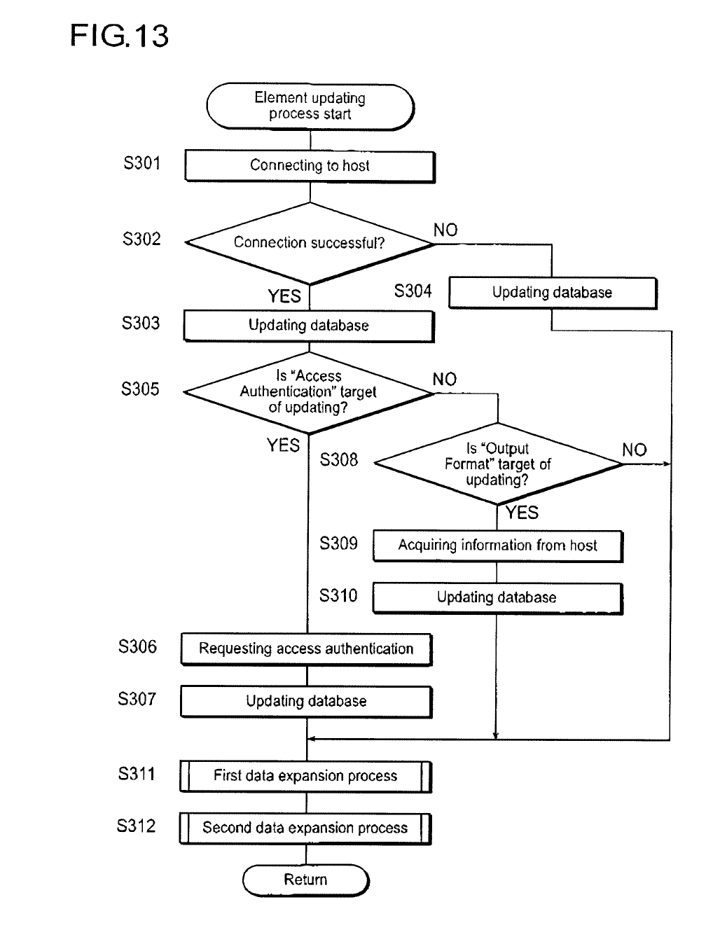

The following is a description of the element updating process (S204). FIG. 13 shows a flowchart showing the sequence of the process.

First of all, the PC 2 attempts to connect to the file server 3 (hereinafter called “host”) equipped with the address folder targeted for updating (S301). If the PC 2 has succeeded in the connection to the host (S302: Yes), the PC 2 updates data on connection constraints to the host in the address folder database D, accordingly (S303). More specifically, the PC 2 rewrites the value of “IsHostAlive” in the table T2 with “true”. The PC 2 then moves to S305. When the PC 2 has failed in the connection to the host (S302: No), the PC 2 updates the data on connection constraints to the host in the address folder database D, accordingly (S304). More specifically, the PC 2 rewrites the value of “IsHostAlive” in the table T2 with “false”. The PC 2 then moves to S311.

In S305, the PC 2 checks whether or not the targeted element for updating is “Access Authentication” (S305), and the rest of the process diverges depending on the check result.

If the targeted element for updating is “Access Authentication” (S305: Yes), the PC 2 makes a request to the host for access authentication to the address folder with reference to the authentication information (the values of “UseName” and “Password”) stored in the table T3 (306). The PC 2 then updates the data in the database D on the access authentication result to the address folder (307). More specifically, the PC 2 rewrites the value of “IsCertValid” in the table T2 with “true” if it has succeeded in the access authentication in S306, while the PC 2 rewrites the value with “false” if it has failed in the access authentication in S306. The PC 2 then moves to S311.

On the other hand, if the targeted element for updating is not “Access Authentication” (S305: No), the PC 2 further checks whether or not the targeted element for updating is “Output Format” (S308). If the targeted element is “Output Format” (S308: Yes), the PC 2 acquires from the host information on the acceptable data format to the address folder (S309), and updates data in the database D based on the information acquired in S309 (S310). More specifically, the PC 2 rewrites the values of “IsTiffEnable”, “IsPdfEnable” and “IsJpegEnable” in the table T2 with the values according to the information from the host. The PC 2 then moves to S311. On the other hand, if the targeted element for updating is not to be “Output Format” (S308: No), the PC 2 moves to S311 without acquiring any further information from the host.

The PC 2 then executes the first data expansion process (S311) for expanding the data updated in the aforementioned process over the other address folders associated with the same user, and the second data expansion process (S312) for expanding the data updated in the aforementioned process over the address folders associated with the other users, and then returns to the flowchart of FIG. 9 (Return). The followings are descriptions of the first and second data expansion processes (S311 and S312).

First Data Expansion Process (S311)

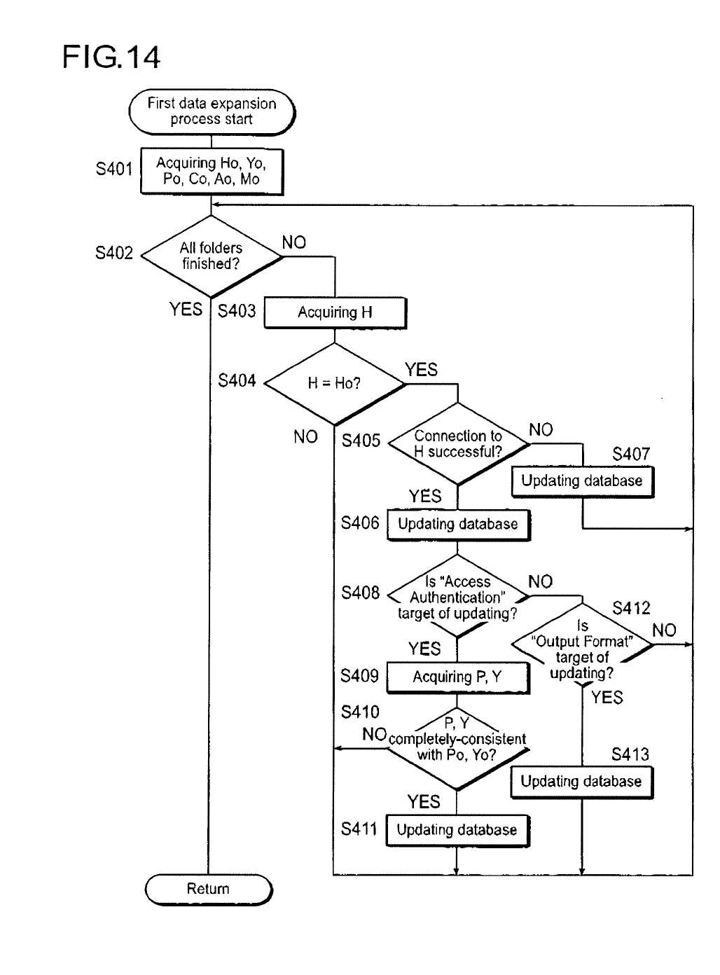

A description of the first data developing process (S311) for expanding the data updated in the database updating process in FIG. 13 over the other address folders associated with the same user is given below with reference to FIG. 14.

First of all, the PC 2 acquires from the address folder database D: name of the host currently targeted for the updating (H0), access authentication information to the address folder currently targeted for the updating (Y0), communication protocol for data delivery to the address folder currently targeted for the updating (P0), connection constraints to the host after the updating in S303/S304 (C0), access authentication results to the address folders from the updating in S307 (A0), and acceptable data format to the address folder after the updating in S310 (M0), all of which will be used for the data expansion (S401). H0, Y0, P0, C0, A0, and M0 correspond to the values of “Hostname”, “Username/Password”, “Protocol”, “IsHostAlive”, “IsCertValid” and “IsTiffEnable/IsPdfEnable/IsJpegEnable” stored in the address folder database D, respectively.

The PC2 subjects all the address folders except for the one currently targeted for the updating to the process of S403-S413 detailed below (S402: No).

First of all, the PC 2 designates any one of the address folders except for the one currently targeted for the updating as an expansion target folder, and acquires from the database D the name of the host (H) equipped with the expansion target folder (S403). The PC 2 then checks whether or not H is identical with H0 acquired in S401 (S404). If H is not identical with H0 (S404: No), meaning that there is no expandable data over the expansion target folder, the PC 2 returns to S402, and subjects the remaining address folders to the data expansion process.

On the other hand, if H is identical with H0 (S404: Yes), the PC 2 moves to S405, and the rest of the process diverges depending on the C0 value indicating connection constraint to the host (H0).

If the host (H0) is not connectable (S405: No) i.e. the “C0” values is “false”, the PC 2 rewrites the “IsHostAlive” value for the expansion target folder with “false” (S407). Now that there is no other expandable data over the expansion target folder, the PC 2 returns to S402, and subjects the remaining folders to the data expansion process.

On the other hand, if the host (H0) is connectable (S405: Yes) i.e. the “C0” value is “true”, the PC 2 rewrites the “IsHostAlive” value for the expansion target folder with “true” (S406), and moves to the step S408.

The process after S408 diverges depending on the check result in the abovementioned S305. In other words, if the targeted element for the updating in the flowchart of FIG. 13 has been “Access Authentication” (S408: Yes), the PC 2 moves to S409, while the PC 2 moves to S412 if the targeted element has not been “Access Authentication”.

In S409, the PC 2 acquires from the database D the “Protocol” value (P) and the “Username/Password” value (Y) for the expansion target folder, and checks whether or not these values (P, Y) are completely-consistent with the values (P0, Y0) acquired in S401 (S410). If they are completely-consistent with each other (S410: Yes), the PC 2 returns to S402 after rewriting the “IsCertValid” value for the expansion target folder with “A0” (S411), and subjects the remaining address folders to the data expansion process. If they are not completely-consistent with each other (S410: No), meaning that there is no other expandable data over the expansion target folder, the PC 2 returns to S413, and subjects the remaining folders to the data expansion process.

The process after S412 diverges depending on the check result in the abovementioned S308. In other words, if the element targeted for the updating in the flowchart of FIG. 13 has been “Output Format” (S412: Yes), the PC 2 returns to S402 after rewriting the value of “IsTiffEnable/IsPdfEnable/IsJPegEnable” for the expansion target folder with MO (S413), and subjects the remaining folders to the data expansion process.

On the other hand, if the element targeted for the updating in the flowchart of FIG. 13 has not been “Output Format” (S412: No), meaning that there is no expandable data over the expansion target folder, the PC 2 returns to S413, and subjects the remaining address folders to the data expansion process.

Second Data Developing Process (S312)

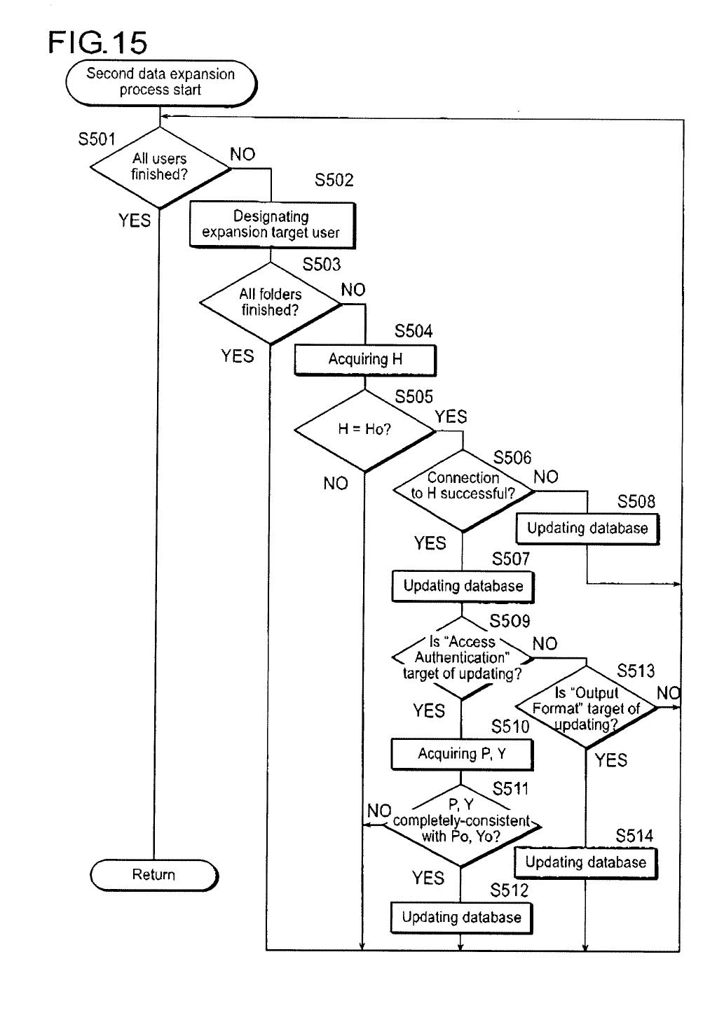

A description of the second data expansion process (S312) for expanding the data updated in the database updating process over the address folders associated with the other users is give below with reference to FIG. 15.

The PC 2 checks whether or not all users except for the log-in user have been finished with the process starting with S502 (S501). If all users have not been finished with the process starting with S502 (S501: No), the PC 2 designates any one of the users yet to be finished with the process after S502 as an expansion target user (S502), and subjects the data corresponding to the expansion target user in the database D to the data expansion process after S503. The data expansion process after S503 is similar to the process after S402, and therefore its details are not discussed.

When the expansion target user has finished with the process after S503, the PC 2 returns to S501 to designate another user as the expansion target user (S502), and subjects the new expansion target user to the process after S503. When all the users have been finished with the data expansion process (S501: Yes), the PC 2 returns to the flowchart of FIG. 13 (Return).

The present embodiment enables the system to expand updated data in the database D for any one of the address folders associated with an user, over data for the other address folders associated with the same user as well as data for the address folders associated with the other users. This will eliminate the need for repeated connections to the host, thereby reducing loads on the network during the database updating process.

### Second Embodiment

The following is a description of the second embodiment focusing on differences from the first embodiment.

System Configuration

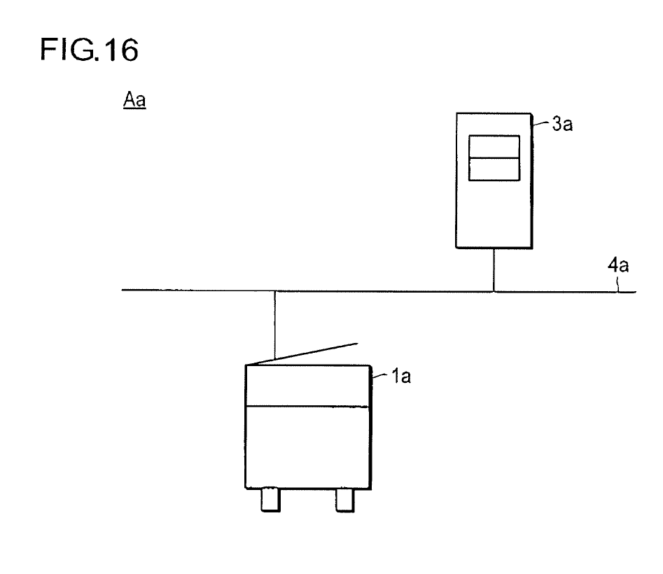

FIG. 16 is a block diagram showing the overall configuration of an image forming system Aa according to the second embodiment of the present invention. As shown in FIG. 16, the image forming system Aa has an MFP 1a equipped with an image scanning function to generate scanned image data and a data delivery function to deliver the scanned image data to the host device specified by the user, and one or more file servers 3a serving as the host devices equipped with delivery destinations of delivered image data, all of which are connected via a communication network 4a such as the Internet, LAN, and WAN. The types and the number of equipments connected to the communication network 4 are not limited to the example shown in FIG. 1. The image forming system Aa of the present embodiment is different from the image forming system A of the first embodiment in that the system Aa does not have an independent data delivery apparatus and the MFP 1a can double as a data delivery apparatus.

The configuration of each device is described below while each of the devices can include any constituents other than those described below and can only include part of the constituents described below. Descriptions of any functions common to more than one device will be made only once, and will not be repeated for avoiding redundancy.

The MFP 1a of the present embodiment contains a control unit 11a, a storage unit 12a, an input unit 13a, an image scanning unit 14a, a printing unit 15a, and a communication interface 16a, all of which are interconnected by a bus 17a for exchanging signals, similar to the first embodiment. The configuration of each unit is similar to that in the first embodiment except for the storage unit 12a and the operating unit 13a, so that descriptions of the storage unit 12a and the operating unit 13a will only follow.

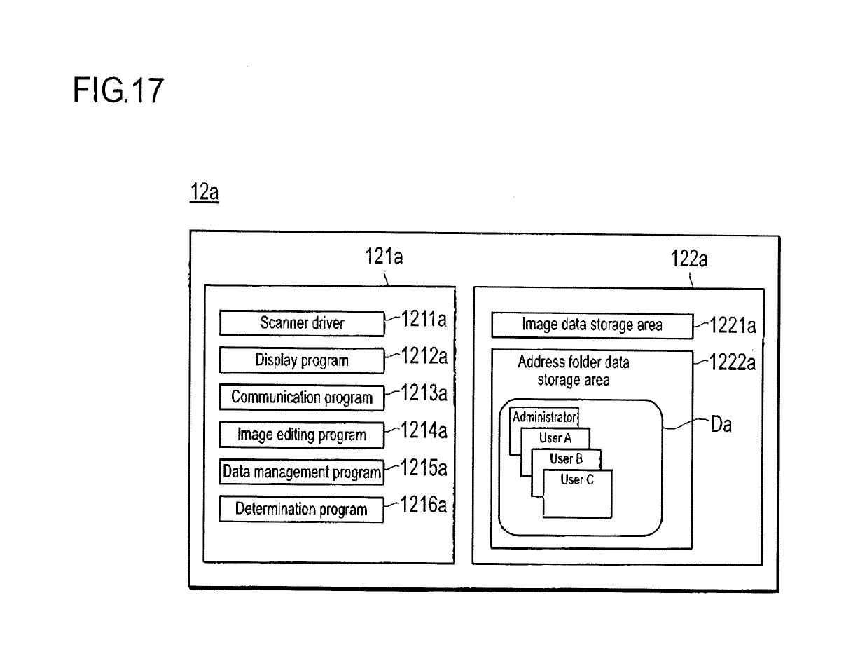

The storage unit 12a includes a ROM for storing various programs and parameters, a RAM for temporarily storing programs and data, a hard disk used for temporarily storing the image data generated by the image scanning unit 14. FIG. 17 is a block diagram showing the configuration of the storage unit 12a. As shown in FIG. 17, the storage unit 12a includes the program storage area 121a for storing various programs, and a data storage area 122a for storing scanned image data for delivery and parameters to be use for execution of the programs. The program storage area 121a and the data storage area 122a are similar to the program storage area 221 and the data storage area 222 in the first embodiment, and therefore their details are not discussed.

The data storage area 122a stores an address folder database Da for collectively managing various kinds of data per user concerning address folders which have been preliminary registered in an address book as possible delivery destinations of the image data. The configuration of the address folder database Da is similar to that of the address folder database D in the first embodiment.

The input unit 13a is equipped with a touch panel 131a for displaying various kinds of information and acquiring various inputs from user. In particular, the touch panel 131a displays the UI screen u2 for user to select delivery destinations of the image data to be generated by the scanning operation. The UI screen u2 will be described later.

The file server 3a of the present embodiment is similar to the file server 3 of the first embodiment, and therefore its details are not discussed. In the following descriptions, the constituent elements of the file server 3a will be represented by the symbols corresponding to the constituent elements of the file server 3 in the first embodiment plus suffix “a”.

UI Screen

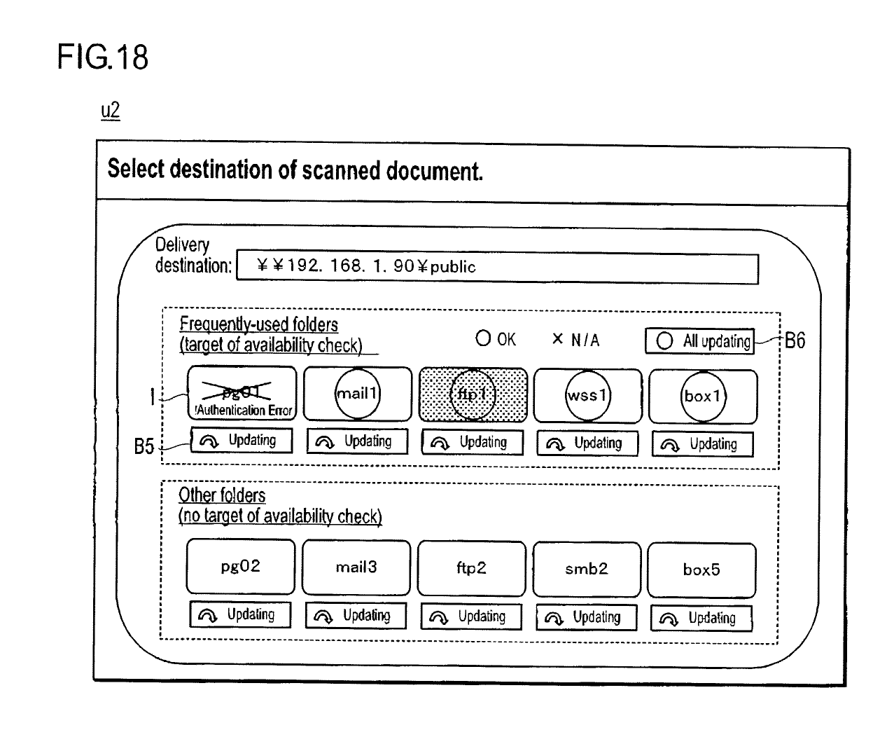

FIG. 18 is a schematic diagram showing an example of the UI screen u2. As described before, the UI screen u2 is displayed on a touch panel 131a when the MFP 1a starts the scanning operation. The touch panel 131a has a smaller displaying area and hence is capable of displaying a smaller amount of information than the display unit 23 in the first embodiment. Therefore, the UI screen u2 of the present embodiment is designed to display a minimal amount of information which will be necessary for user to check availability of each address folder, etc.

As shown in FIG. 18, the UI screen u2 can display not only information indicating availability of each address folder associated with log-in user, but also information indicating the reason why some of the address folders are not available at this moment. More specifically, the UI screen u2 is equipped with icons I, each of which corresponds to each address folder and contains either a circle or a cross mark indicating availability of the address folder as well as an error message (a text like “Authentication Error”) accompanying each cross mark.

The UI screen u2 of the present embodiment is capable of displaying the icons I each of which corresponding to each address folder in certain groups. In FIG. 18, the icons I are divided into “Frequently-used folders” and “Other folders” depending of the frequency in data delivery to each folder, and these groups are made distinct from each other.

The UI screen u2 of the present embodiment has a function to acquire user's instruction refresh the contents, in addition to the function to display availability of each address folder as shown in the above. Specifically, the UI screen u2 of FIG. 18 is equipped with “Icon Updating” buttons B5 for updating the contents per icon, and “Group Updating” buttons B6 for updating the contents per group. The followings are descriptions of the two kinds of updating buttons B5 and B6.

Each “Icon Updating” button B5 is located in vicinity of each icon I, and user will push this button in order to update the displayed information on availability to the address folder corresponding to an icon I. This means that the process triggered by the button B5 in this embodiment is similar to the process triggered by the “Row Updating” button B3.

The UI screen u2 is provided with one “Group Updating” button B6, and user will push this button in order to update displayed information on availability of all the address folders belonging to a certain group. In the example shown in FIG. 18, user will push the button B6 in order to update the displayed information on availability of all the address folders belonging to the group of “Frequently-used folders”.

User will finally highlight an icon I containing a circle by clicking it, in order to designate the address folder corresponding to the clicked icon I as a delivery destination folder.

Flowchart

In the present embodiment, the MFP 1a executes various processes similar to the image data delivery process and the database updating process shown in the flowcharts of FIG. 8-15 according to the first embodiment. Therefore, details of these processes are not discussed here. Nevertheless, user-selectable units for the updating in the present embodiment differs from those in the first embodiment, and therefore the MFP 1a executing the process corresponding to the flowchart in FIG. 9 checks which one of “Icon Updating” and “Group Updating” has been chosen by user, and lets the rest of the process diverge in accordance with the check result.

As can be seen in the above, the image forming system in the present embodiment can exert the same effects as in the first embodiment although it has a simpler configuration deprived of an independent data delivery apparatus.

This invention is not limited to the embodiments described above, but also can be changed in various ways within the range of the claims. The data delivery apparatus and the data delivery method according to this invention can be realized by a dedicated hardware circuit for executing the abovementioned steps, or by causing a CPU to execute a program where said steps are described. If the present invention is to be materialized by the latter, said programs for operating the data delivery apparatus can be provided by computer-readable recording media such as a floppy disk (a registered trademark) and CD-ROM, or can be provided on-line via a network such as Internet. In this case, the program recorded on the computer readable recording medium is normally transmitted to and stored in a memory device such as ROM and a hard disk. The program can also be provided as independent application software or can be built into the software of the data delivery apparatus as a part of its function.

What is claimed is:

1. A data delivery apparatus for data delivery to more than one folder on external equipments, comprising:
a storage unit for storing information on one or more data receiving constraints imposed on each of said folders;
a determination unit for determining whether or not each of said folders is available for said data delivery by checking whether or not the current data delivery settings will clear all of said one or more data receiving constraints on each of said folders;
a display unit for displaying availability information indicating determination result by said determination unit, which will be accompanied, if any of said data receiving constraints will not be cleared, by messages notifying that said any data receiving constraints will not be cleared;
an acquisition unit for acquiring user's designation of destination folders for said data delivery among those which said determination unit has determined that are available for said data delivery; and
a data delivery unit for executing said data delivery to said destination folders according to said designation acquired by said acquisition unit.

2. The data delivery apparatus as claimed in claim 1, wherein
said data receiving constraints include at least those attributed to connection constraint to said external equipments, access constraint to said folders, or meta-information of said folders.

3. The data delivery apparatus as claimed in claim 1, wherein
said display unit is capable of displaying information on those among said folders which said determination unit has determined that are not available for said data delivery, in distinction from information on those among said folders which said determination unit has determined that are available for said data delivery.

4. The data delivery apparatus as claimed in claim 1, wherein
at least part of said folders are managed by a document management application installed on said external equipments; and
said data receiving constraints on those among said folders which are managed by said document management application are prescribed by said document management application.

5. An image forming system comprising said data delivery apparatus as claimed in claim 1, and a scanner connected to said data delivery apparatus, wherein
said data is image data generated through scanning operation by said scanner; and
said display unit is capable of displaying said availability information and said messages, if any, prior to said scanning operation.

6. A data delivery method for data delivery to more than one folder on external equipments, comprising:
a storing step for storing information on one or more data receiving constraints imposed on each one of said folders;
a determination step for determining whether or not each of said folders is available for said data delivery by checking whether or not the current data delivery settings will clear all of said one or more data receiving constraints on each of said folders;
a display step for displaying availability information indicating determination result in said determination step, which will be accompanied, if any of said data receiving constraints will not be cleared, by messages notifying that said any data receiving constraints will not be cleared;
an acquisition step for acquiring user's designation of destination folders for said data delivery among those which have been determined to be available for said data delivery in said determination step; and
a data delivery step for executing said data delivery to said destination folders according to said designation acquired in said acquisition step.

7. The data delivery method as claimed in claim 6, wherein
said data receiving constraints include at least those attributed to connection constraint to said external equipments, access constraint to said folders, or meta-information of said folders.

8. The data delivery method as claimed in claim 6, wherein
in said display step, information on those among said folders which have been determined not to be available for said date delivery in said determination step is displayed in distinction from the other information.

9. The data delivery method as claimed in claim 6, wherein
at least part of said folders are managed by a document management application installed on said external equipments; and
said data receiving constraints on those among said folders which are managed by said document management application are prescribed by said document management application.

10. The data delivery method as claimed in claim 6, wherein
said data is image data generated through scanning operation by a scanner; and
said display step can be executed prior to said scanning operation.

11. A computer readable recording medium stored with a program for data delivery to more than one folder provided external equipments, said program causing a computer to execute a process comprising:
a storing step (a) for storing information on one or more data receiving constraints imposed on each one of said folders;
a step (b) for determining whether or not each of said folders is available for said data delivery by checking whether or not the current data delivery settings will clear all of said one or more data receiving constraints on each of said folders;
a step (c) for displaying availability information indicating determination result in said determination step, which will be accompanied, if any of said data receiving constraints will not be cleared, by messages notifying that said any data receiving constraints will not be cleared;
a step (d) for acquiring user's designation of destination folders for said data delivery among those which have been determined to be available for said data delivery in said step (b); and
a step (e) for executing said data delivery to said destination folders according to said designation acquired in said step (d).

12. The computer readable recording medium as claimed in claim 11, wherein
said data receiving restrictions include at least those attributed to connection constraint to said external equipments, access constraint to said folders, or meta-information of said folders.

13. The computer readable recording medium as claimed in claim 11, wherein
in said step (c), information on those among said folders which have been determined not to be available for said data delivery in said step (b) is displayed in distinction from the other information.

14. The computer readable recording medium as claimed in claim 11, wherein
at least part of said folders are managed by a document management application installed on said external equipments; and
said data receiving constraints on those among said folders which are managed by said document management application are prescribed by said document management application.

15. The computer readable recording medium as claimed in claim 11, wherein
said data is image data generated through scanning operation by a scanner; and
said step (c) can be executed prior to said scanning operation.
